(19) United States
(12) Patent Application Publication
(10) Pub. No.: US 2018/0324906 A1
(43) Pub. Date: Nov. 8, 2018

(54) ELECTRIC OVEN

(71) Applicants: GUANGDONG MIDEA KITCHEN APPLIANCES MANUFACTURING CO., LTD., Foshan (CN); MIDEA GROUP CO., LTD., Foshan (CN)

(72) Inventors: Chaohui Liu, Foshan (CN); Jianghua Wang, Foshan (CN)

(73) Assignees: GUANGDONG MIDEA KITCHEN APPLIANCES MANUFACTURING CO., LTD., Foshan (CN); MIDEA GROUP CO., LTD., Foshan (CN)

(21) Appl. No.: 15/654,725

(22) Filed: Jul. 20, 2017

(30) Foreign Application Priority Data
May 5, 2017 (CN) 201720498730.8

(51) Int. Cl. H05B 6/64; H05B 6/80; A23L 5/10

(52) U.S. Cl. CPC H05B 6/6411; H05B 6/00; A23L 5/15; H05B 6/80

(57) ABSTRACT

The present invention provides an electric oven, including a cooking cavity, wherein a plurality of upper heating tubes are installed at a top position in the cooking cavity, and a plurality of lower heating tubes are installed at a bottom position in the cooking cavity. The solution improves the arrangement structure of the heating tubes of the electric oven in that at least one of the upper heating tubes protrudes from the horizontal plane where the other upper heating tubes are located, and/or at least one of the lower heating tubes protrudes from the horizontal plane where the other lower heating tubes are located, such that the distribution of the heating tubes is more stereoscopic, and the distribution of heat generated by the heating tubes in the cooking cavity is more uniform, and accordingly the heating uniformity is improved.

### CROSS-REFERENCES TO RELATED APPLICATIONS

The present application claims the priority and benefit of Chinese Patent Application No. 201720498730.8, filed on May 5, 2017, the contents of which is incorporated herein by reference in its entirety.

### FIELD OF THE INVENTION

The present invention relates to the field of cooking appliances, and more specifically, to a rotating tray assembly and a cooking appliance.

### BACKGROUND OF THE INVENTION

An electric oven is usually provided with two layers of heating tubes at the top and the bottom in a cooking cavity, and food is placed between upper heating tubes and lower heating tubes to be roasted. The arrangement mode of the heating tubes of the existing electric oven product is shown in FIG. 1, wherein in a cooking cavity 1′, upper heating tubes 2′ are installed in the same horizontal plane, and lower heating tubes 3′ are installed in the same horizontal plane; and the upper and lower heating tubes are arranged oppositely. This highly symmetrical arrangement structure of the heating tubes causes non-uniform heat distribution in the cooking cavity 1′, the roasted food is prone to the problem of being “half raw and half cooked”, and thus the structure of the existing electric oven still needs to be improved.

### SUMMARY OF THE INVENTION

The objective of the present invention is to solve at least one of the technical problems in the prior art.

To this end, an objective of the present invention is to provide an electric oven with good heating uniformity.

Another objective of the present invention is to provide a steam microwave oven, including the electric oven mentioned above.

To achieve the objectives mentioned above, an embodiment of the present invention provides an electric oven, including a cooking cavity, wherein a plurality of upper heating tubes are installed at a top position in the cooking cavity, a plurality of lower heating tubes are installed at a bottom position in the cooking cavity, and at least one of the plurality of upper heating tubes has an installation height different from those of the other upper heating tubes; and/or at least one of the plurality of lower heating tubes has an installation height different from those of the other lower heating tubes.

The solution improves the arrangement structure of the heating tubes of the electric oven in that at least one of the upper heating tubes protrudes from the horizontal plane where the other upper heating tubes are located, and/or at least one of the lower heating tubes protrudes from the horizontal plane where the other lower heating tubes are located, such that the distribution of the heating tubes is more stereoscopic, and the distribution of heat generated by the heating tubes in the cooking cavity is more uniform, and accordingly the heating uniformity is improved. It is worth noting that the solution just adjusts the installation positions of the heating tubes in a small amplitude, the upper heating tubes are still close to the top of the cooking cavity, and the lower heating tubes are still close to the bottom of the cooking cavity so as to ensure that the space for placing food in the cooking cavity is not decreased, and few changes are made to the structure of the cooking cavity in the design, which is very conducive to controlling the product cost.

According to an embodiment of the present invention, the installation height of at least one of the plurality of upper heating tubes is lower than those of the other upper heating tubes.

In the solution, as the installation height of at least one of the upper heating tubes is lower than those of the other upper heating tubes, the plurality of upper heating tubes generate vertical height differences, so the distribution of the heating tubes in the cooking cavity is more stereoscopic, and thus the heating uniformity is improved.

In the above-mentioned technical solution, optionally, a first upper heating tube, a second upper heating tube and a third upper heating tube are successively installed at the top position in the cooking cavity from front to back, the first upper heating tube and the third upper heating tube are installed in the same horizontal plane, and the installation position of the second upper heating tube is lower than those of the first upper heating tube and the third upper heating tube.

In the solution, three upper heating tubes are installed at the top of the cooking cavity, and the installation position of the second upper heating tube at the middle is lower than the plane where the other two upper heating tubes are located, such that the plurality of upper heating tubes generate vertical height differences, the distribution of the heating tubes in the cooking cavity is more stereoscopic, and thus the heating uniformity is improved.

According to an embodiment of the present invention, the installation height of at least one of the plurality of upper heating tubes is higher than those of the other upper heating tubes.

In the solution, as the installation height of at least one of the upper heating tubes is higher than those of the other upper heating tubes, the plurality of upper heating tubes generate vertical height differences, so the distribution of the heating tubes in the cooking cavity is more stereoscopic, and thus the heating uniformity is improved.

In the above-mentioned technical solution, optionally, a first upper heating tube, a second upper heating tube and a third upper heating tube are successively installed at the top position in the cooking cavity from front to back, the first upper heating tube and the third upper heating tube are installed in the same horizontal plane, and the installation position of the second upper heating tube is higher than those of the first upper heating tube and the third upper heating tube.

In the solution, three upper heating tubes are installed at the top of the cooking cavity, and the installation position of the second upper heating tube at the middle is higher than the plane where the other two upper heating tubes are located, such that the plurality of upper heating tubes generate vertical height differences, the distribution of the heating tubes in the cooking cavity is more stereoscopic, and thus the heating uniformity is improved.

In any one of the above-mentioned technical solutions, optionally, a first lower heating tube and a second lower heating tube are installed at the bottom position in the cooking cavity.

In any one of the above-mentioned technical solutions, optionally, the first lower heating tube is opposite to the first upper heating tube, and the second lower heating tube is opposite to the third upper heating tube.

In the solution, when the installation positions of the upper heating tubes are adjusted, the layout structure of the existing lower heating tubes is retained, and the positions of the lower heating tubes are not adjusted, and few changes are made to the structure of the cooking cavity in this design, which is very conducive to controlling the product cost

In any one of the above-mentioned technical solutions, optionally, the first lower heating tube is opposite to a gap between the first upper heating tube and the second upper heating tube, and the second lower heating tube is opposite to a gap between the second upper heating tube and the third upper heating tube.

In the solution, when the installation positions of the upper heating tubes are adjusted, the installation positions of the lower heating tubes are adjusted as well, so that the originally opposite upper and lower heating tubes are staggered to each other for a certain distance, therefore the plurality of upper and lower heating tubes generate horizontal distance differences, the distribution of the heating tubes in the cooking cavity is more stereoscopic, and thus the heating uniformity is improved.

In any one of the above-mentioned technical solutions, optionally, the upper heating tubes and the lower heating tubes are metal tubes, quartz tubes, lightwave tubes or far infrared tubes.

In any one of the above-mentioned technical solutions, optionally, when three or more upper heating tubes are deployed, the horizontal distances between every two adjacent upper heating tubes are equal; and when three or more lower heating tubes are deployed, the horizontal distances between every two adjacent lower heating tubes are equal.

The horizontal distances of the heating tubes refer to the distances of positive projections of the heating tubes on the horizontal plane. In the solution, the upper heating tubes and the lower heating tubes are horizontally arranged at equal horizontal intervals respectively, due to such a design, the distribution of the heating tubes in the cooking cavity is more stereoscopic as a result, and thus the heating uniformity is can be improved.

Additional aspects and advantages of the present invention will become apparent from the following description, or may be learned from the practice of the present invention.

### BRIEF DESCRIPTION OF THE DRAWINGS

The foregoing and/or additional aspects and advantages of the present invention will become apparent and readily understandable from the following description of the embodiments in conjunction with the accompanying drawings, wherein:

FIG. 1 is a structural schematic diagram of an electric oven in the prior art; a corresponding relation between reference signs and component names in FIG. 1 is as follows: 1′ cooking cavity, 2′ upper heating tube, 3′ lower heating tube.

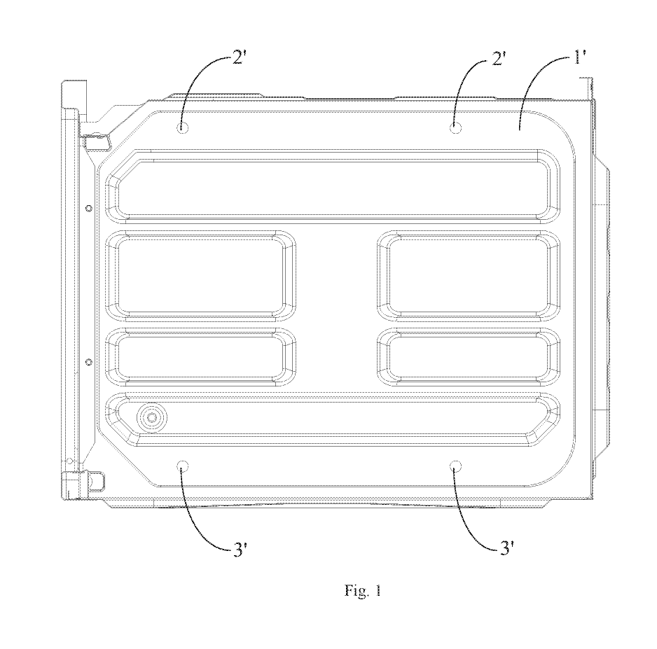

FIG. 2 is a schematic diagram of a stereoscopic structure of an electric oven provided by a first embodiment of the present invention;

FIG. 3 is a structural schematic diagram of the electric oven as shown in FIG. 2 viewed from another angle;

FIG. 4 is a schematic diagram of a structure of an electric oven provided by a second embodiment of the present invention;

FIG. 5 is a schematic diagram of a structure of an electric oven provided by a third embodiment of the present invention;

FIG. 6 is a schematic diagram of a structure of an electric oven provided by a fourth embodiment of the present invention.

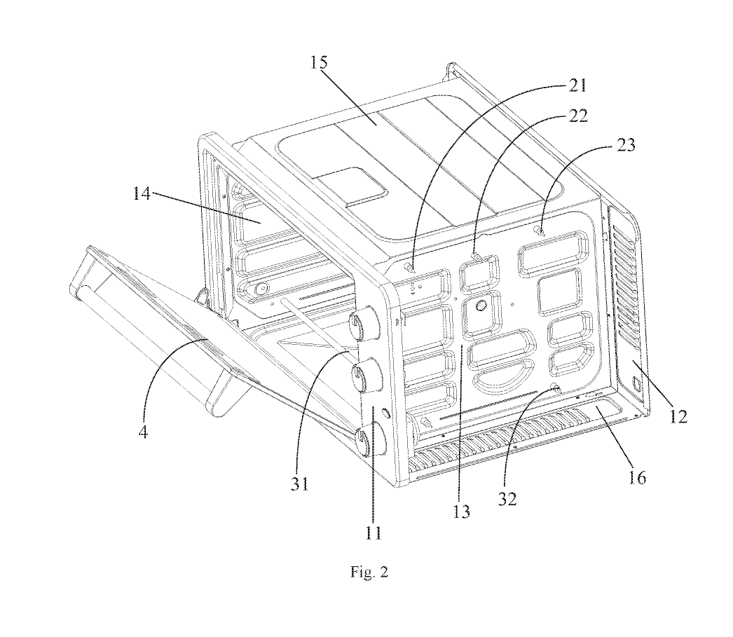

A corresponding relation between reference signs and component names in FIGS. 2 to 6 is as follows:

1 cooking cavity, 11 front plate, 12 back plate, 13 left side plate, 14 right side plate, 15 top plate, 16 bottom plate, 21 first upper heating tube, 22 second upper heating tube, 23 third upper heating tube, 31 first lower heating tube, 32 second lower heating tube, and 4 oven door.

### DETAILED DESCRIPTION OF THE EMBODIMENTS

In order that the above-mentioned objects, features and advantages of the present invention are clearer, a further detailed description of the present invention will be given below in combination with accompanying drawings and embodiments. It should be noted that the embodiments and the features in the embodiments of the present application may be combined with each other without conflict.

Numerous specific details are set forth in the following description to facilitate a thorough understanding of the present invention, but the present invention may be implemented in other manners different from that described herein, and thus the protection scope of the present invention is not limited to the specific embodiments disclosed below.

Embodiments of the present invention provide an electric oven, as shown in FIGS. 2 to 6, including a cooking cavity 1, wherein a plurality of upper heating tubes are installed at a top position in the cooking cavity 1, a plurality of lower heating tubes are installed at a bottom position in the cooking cavity 1, and at least one of the plurality of upper heating tubes has an installation height different from those of the other upper heating tubes; and/or at least one of the plurality of lower heating tubes has an installation height different from those of the other lower heating tubes.

The solution improves the arrangement structure of the heating tubes of the electric oven in that at least one of the upper heating tubes protrudes from the horizontal plane where the other upper heating tubes are located, and/or at least one of the lower heating tubes protrudes from the horizontal plane where the other lower heating tubes are located, such that the distribution of the heating tubes is more stereoscopic, and the distribution of heat generated by the heating tubes in the cooking cavity 1 is more uniform, and accordingly the heating uniformity is improved. It is worth noting that the solution just adjusts the installation positions of the heating tubes in a small amplitude, the upper heating tubes are still close to the top of the cooking cavity 1, and the lower heating tubes are still close to the bottom of the cooking cavity 1 so as to ensure that the space for placing food in the cooking cavity 1 is not decreased, and few changes are made to the structure of the cooking cavity 1 in the design, which is very conducive to controlling the product cost.

The cooking cavity 1 is enclosed by a front plate 11, a back plate 12, a left side plate 13, a right side plate 14, a top plate 15 and a bottom plate 16, an oven door 4 is hinged on the cooking cavity 1 so as to control the opening and closing of the cooking cavity 1, and both ends of the upper and lower heating tubes are respectively fixed to the left and right side plates of the cooking cavity 1.

Specifically, the specific arrangement mode of the heating tubes in the cooking cavity includes a plurality of implementation solutions:

### First Embodiment

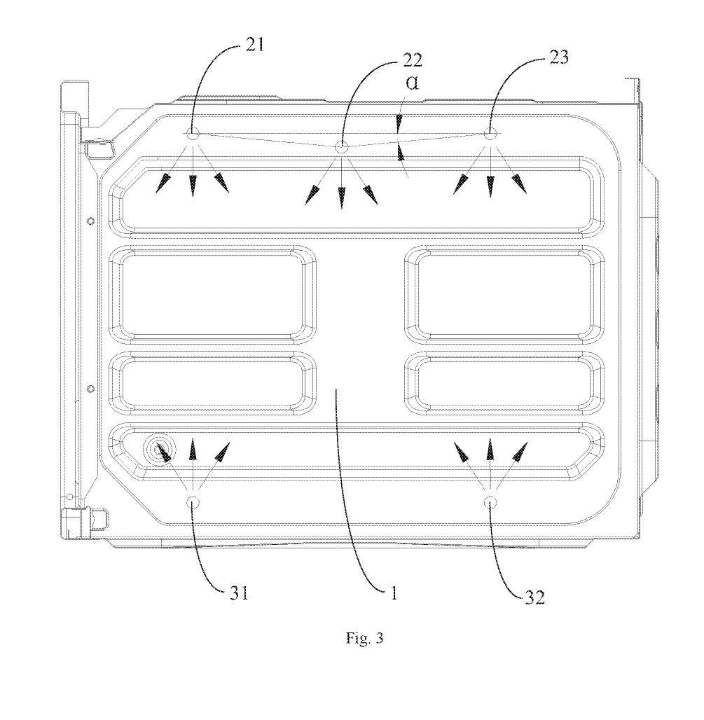

As shown in FIGS. 2 and 3, a first upper heating tube 21, a second upper heating tube 22 and a third upper heating tube 23 are successively installed at the top position in the cooking cavity 1 from front to back, the first upper heating tube 21 and the third upper heating tube 23 are installed in the same horizontal plane, and the installation position of the second upper heating tube 22 is lower than those of the first upper heating tube 21 and the third upper heating tube 23, so that the three upper heating tubes are staggered to each other for an angle a in a vertical plane; and a first lower heating tube 31 and a second lower heating tube 32 are installed at the bottom position in the cooking cavity 1, the first lower heating tube 31 is opposite to the first upper heating tube 21, and the second lower heating tube 32 is opposite to the third upper heating tube 23.

In the solution, three upper heating tubes are installed at the top of the cooking cavity 1, and the installation position of the second upper heating tube at the middle is lower than the plane where the other two upper heating tubes are located, such that the plurality of upper heating tubes generate vertical height differences, the distribution of the heating tubes in the cooking cavity 1 is more stereoscopic, and thus the heating uniformity is improved. Moreover, in the solution, when the installation positions of the upper heating tubes are adjusted, the layout structure of the existing lower heating tubes is retained, and the positions of the lower heating tubes are not adjusted, and few changes are made to the structure of the cooking cavity 1 in this design, which is very conducive to controlling the product cost.

### Second Embodiment

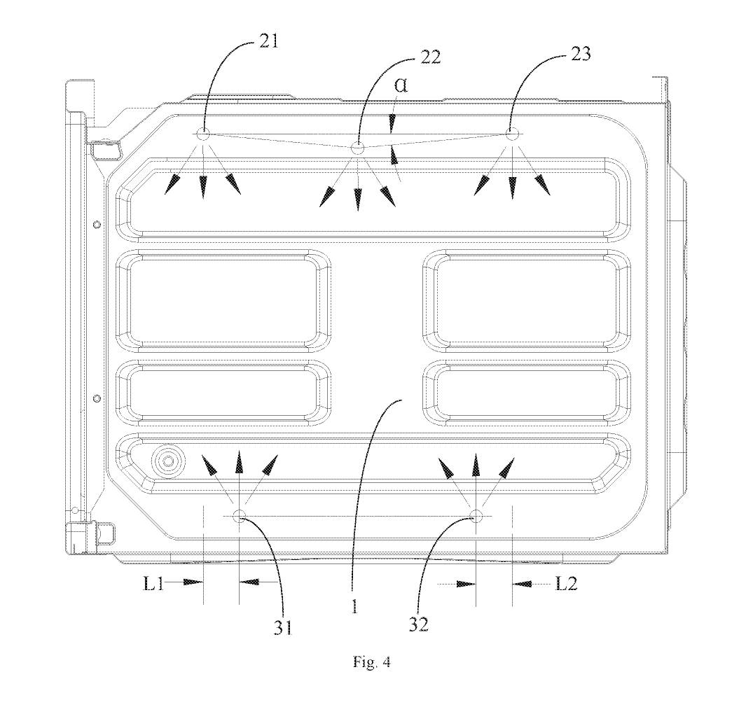

As shown in FIG. 4, a first upper heating tube 21, a second upper heating tube 22 and a third upper heating tube 23 are successively installed at the top position in the cooking cavity 1 from front to back, the first upper heating tube 21 and the third upper heating tube 23 are installed in the same horizontal plane, and the installation position of the second upper heating tube 22 is lower than those of the first upper heating tube 21 and the third upper heating tube 23, so that the three upper heating tubes are staggered to each other for an angle α in a vertical plane; and a first lower heating tube 31 and a second lower heating tube 32 are installed at the bottom position in the cooking cavity 1, the first lower heating tube 31 is opposite to a gap between the first upper heating tube 21 and the second upper heating tube 22, so the first lower heating tube 31 is staggered to the first upper heating tube 21 for a horizontal distance L1, and the second lower heating tube 32 is opposite to a gap between the second upper heating tube 22 and the third upper heating tube 23, so the second lower heating tube 32 is staggered to the third upper heating tube 23 for a horizontal distance L2.

In the solution, three upper heating tubes are installed at the top of the cooking cavity 1, and the installation position of the second upper heating tube at the middle is lower than the plane where the other two upper heating tubes are located, such that the plurality of upper heating tubes generate vertical height differences, the distribution of the heating tubes in the cooking cavity 1 is more stereoscopic, and thus the heating uniformity is improved. Moreover, in the solution, when the installation positions of the upper heating tubes are adjusted, the installation positions of the lower heating tubes are adjusted as well, the originally opposite upper and lower heating tubes are staggered to each other for a certain distance, therefore the plurality of upper and lower heating tubes generate horizontal distance differences, the distribution of the heating tubes in the cooking cavity 1 is more stereoscopic, and thus the heating uniformity is improved.

### Third Embodiment

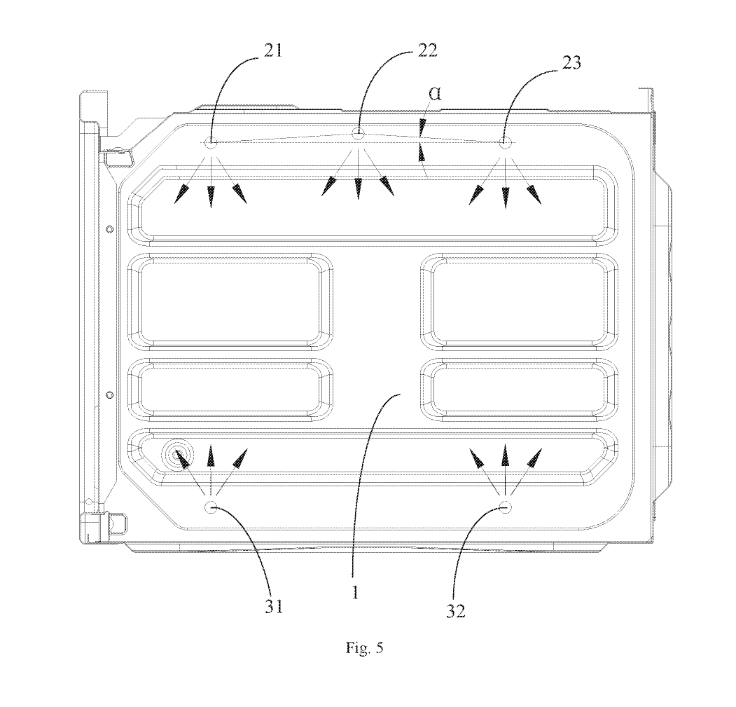

As shown in FIG. 5, a first upper heating tube 21, a second upper heating tube 22 and a third upper heating tube 23 are successively installed at the top position in the cooking cavity 1 from front to back, the first upper heating tube 21 and the third upper heating tube 23 are installed in the same horizontal plane, and the installation position of the second upper heating tube 22 is higher than those of the first upper heating tube 21 and the third upper heating tube 23, so that the three upper heating tubes are staggered to each other for an angle a in a vertical plane; and a first lower heating tube 31 and a second lower heating tube 32 are installed at the bottom position in the cooking cavity 1, the first lower heating tube 31 is opposite to the first upper heating tube 21, and the second lower heating tube 32 is opposite to the third upper heating tube 23.

In the solution, three upper heating tubes are installed at the top of the cooking cavity 1, and the installation position of the second upper heating tube at the middle is higher than the plane where the other two upper heating tubes are located, such that the plurality of upper heating tubes generate vertical height differences, the distribution of the heating tubes in the cooking cavity 1 is more stereoscopic, and thus the heating uniformity is improved. Moreover, in the solution, when the installation positions of the upper heating tubes are adjusted, the layout structure of the existing lower heating tubes is retained, and the positions of the lower heating tubes are not adjusted, and few changes are made to the structure of the cooking cavity 1 in this design, which is very conducive to controlling the product cost.

### Fourth Embodiment

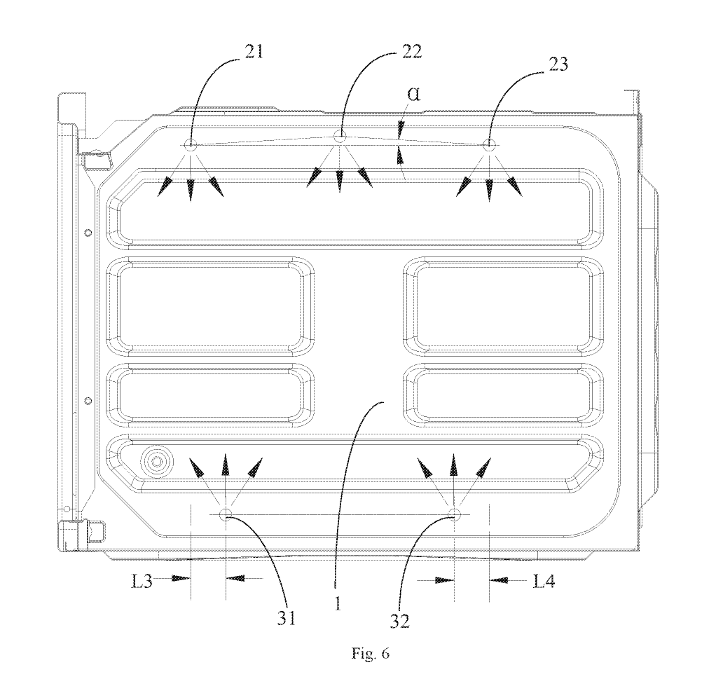

As shown in FIG. 6, a first upper heating tube 21, a second upper heating tube 22 and a third upper heating tube 23 are successively installed at the top position in the cooking cavity 1 from front to back, the first upper heating tube 21 and the third upper heating tube 23 are installed in the same horizontal plane, and the installation position of the second upper heating tube 22 is higher than those of the first upper heating tube 21 and the third upper heating tube 23, so that the three upper heating tubes are staggered to each other for an angle α in a vertical plane; and a first lower heating tube 31 and a second lower heating tube 32 are installed at the bottom position in the cooking cavity 1, the first lower heating tube 31 is opposite to a gap between the first upper heating tube 21 and the second upper heating tube 22, so the first lower heating tube 31 is staggered to the first upper heating tube 21 for a horizontal distance L3, and the second lower heating tube 32 is opposite to a gap between the second upper heating tube 22 and the third upper heating tube 23, so the second lower heating tube 32 is staggered to the third upper heating tube 23 for a horizontal distance L4.

In the solution, three upper heating tubes are installed at the top of the cooking cavity 1, and the installation position of the second upper heating tube at the middle is higher than the plane where the other two upper heating tubes are located, such that the plurality of upper heating tubes generate vertical height differences, the distribution of the heating tubes in the cooking cavity 1 is more stereoscopic, and thus the heating uniformity is improved. Moreover, in the solution, when the installation positions of the upper heating tubes are adjusted, the installation positions of the lower heating tubes are adjusted as well, the originally opposite upper and lower heating tubes are staggered to each other for a certain distance, therefore the plurality of upper and lower heating tubes generate horizontal distance differences, the distribution of the heating tubes in the cooking cavity 1 is more stereoscopic, and thus the heating uniformity is improved.

It should be noted that, in the four embodiments mentioned above, the sizes of the angles a may be equal or not, and L1, L2, L3 and L4 may be equal or not.

It should be understood that the design solution protected by the present invention includes, but not limited to, the above four types, not only can the relative heights of the plurality of upper heating tubes be adjusted, but also the relative heights of the plurality of lower heating tubes can be adjusted; or when the relative heights of the plurality of upper heating tubes are adjusted, the relative heights of the plurality of lower heating tubes are adjusted as well. In addition, the number of upper and lower heating tubes and the relative positions of the heating tubes in the horizontal direction may be adjusted.

In any one of the above-mentioned technical solutions, optionally, the upper heating tubes and the lower heating tubes are metal tubes, quartz tubes, lightwave tubes or far infrared tubes.

In any one of the above-mentioned technical solutions, optionally, when three or more upper heating tubes are deployed, the horizontal distances between every two adjacent upper heating tubes are equal; and when three or more lower heating tubes are deployed, the horizontal distances between every two adjacent lower heating tubes are equal.

The horizontal distances of the heating tubes refer to the distances of positive projections of the heating tubes on the horizontal plane. In the solution, the upper heating tubes and the lower heating tubes are horizontally arranged at intervals arranged at equal horizontal intervals, due to such a design, the distribution of the heating tubes in the cooking cavity is more stereoscopic, and thus the heating uniformity is improved.

In the description of the present invention, the orientational or positional relationships indicated by the terms “upper”, “lower”, “top”, “bottom”, “front”, “back”, “left”, “right” and the like are orientational or positional relationships based on illustration in the drawings, are intended to merely facilitate the description of the present invention and simplify the description, rather than indicating or implying that the denoted devices or elements may have particular orientations and may be constructed and operated in particular orientations, and thus should not be understood as limitations to the present invention.

In the description of this specification, the description of the terms “one embodiment”, “some embodiments”, “specific embodiments” and the like means that the specific features, structures, materials or characteristics described in combination with the embodiments or examples are included in at least one embodiment or example of the present invention. In the present specification, the schematic expression of the above-mentioned terms does not necessarily refer to the same embodiment or example. Moreover, the particular features, structures, materials or characteristics described may be combined in any one or more embodiments or examples in a suitable manner.

In the description of the present invention, the terms “connection”, “installation”, “fixation” and the like should be broadly understood. For example, the “connection” can be fixed connection and can also be detachable connection, or integral connection; and can be direct connection, can also be indirect connection through an intermediary. Those of ordinary skill in the art can understand the specific meaning of the above-mentioned terms in the present invention in light of specific circumstances.

The foregoing descriptions are merely preferred embodiments of the present invention, rather than limiting the present invention. For those skilled in the art, the present invention may have various variations and changes. Any modifications, equivalent substitutions, improvements and the like made within the spirit and principle of the present invention shall all fall within the protection scope of the present invention.

1. An electric oven, comprising:
a cooking cavity defined by a plurality of plates including a top plate and a bottom plate, a plurality of upper heating tubes arranged at a top position in the cooking cavity, and a plurality of lower heating tubes arranged at a bottom position in the cooking cavity, wherein
the plurality of the upper heating tubes include a first upper heating tube and a second upper heating tube, wherein the first upper heating tube is arranged closer to the top plate than the second upper heating tube; and
the plurality of the lower heating tubes include a first lower heating tube and a second lower heating tube, wherein the first lower heating tube is arranged closer to the bottom plate than the second lower heating tube.

2. (canceled)

3. The electric oven of claim 2, wherein the plurality of the upper heating tubes include a third upper heating plate, wherein
the first upper heating tube, the second upper heating tube and the third upper heating tube are successively, installed at the top position in the cooking cavity from front to back, the first upper heating tube and the third upper heating tube are installed in the same horizontal plane, and the installation position of the second upper heating tube is lower than those of the first upper heating tube and the third upper heating tube.

4. The electric oven of claim 1, wherein
a height of at least one of the plurality of upper heating tubes is higher than those of the other upper heating tubes.

5. The electric oven of claim 4, wherein the plurality of the upper heating tubes include a third upper heating plate, wherein
the first upper heating tube, the second upper heating tube and the third upper heating tube are successively installed at the top position in the cooking cavity from front to back, the first upper heating tube and the third upper heating tube are installed in the same horizontal plane, and the installation position of the second upper heating tube is higher than those of the first upper heating tube and the third upper heating tube.

6. (canceled)

7. The electric oven of claim 1, wherein
the first lower heating tube is opposite to the first upper heating tube, and the second lower heating tube is opposite to the third upper heating tube.

8. The electric oven of claim 1, wherein
the first lower heating tube is opposite to a gap between the first upper heating tube and the second upper heating tube, and the second lower heating tube is opposite to a gap between the second upper heating tube and the third upper heating tube.

9. The electric oven of claim 1, wherein
the upper heating tubes and the lower heating tubes include metal tubes, quartz tubes, lightwave tubes or far infrared tubes.

10. The electric oven of claim 1, wherein
the upper heating tubes and the lower heating tubes are metal tubes, quartz tubes, lightwave tubes or far infrared tubes.

11. The electric oven of claim 1, wherein
the upper heating tubes and the lower heating tubes are one or more of the following: metal tubes, quartz tubes, lightwave tubes, or far infrared tubes.

12. The electric oven of claim 1, wherein
when three or more upper heating tubes are deployed, the horizontal distances between every two adjacent upper heating tubes are equal; and
when three or more lower heating tubes are deployed, the horizontal distances between every two adjacent lower heating tubes are equal.
